(19) United States
(12) Patent Application Publication
(10) Pub. No.: US 2017/0289033 A1
(43) Pub. Date: Oct. 5, 2017

(54) ADDRESS CACHE FOR TUNNEL ENDPOINT ASSOCIATED WITH AN OVERLAY NETWORK

(71) Applicant: HEWLETT PACKARD ENTERPRISE DEVELOPMENT LP, Houston, TX (US)

(72) Inventors: Santosh Kumar SINGH, Bangalore (IN); Krishna Mouli TANKALA, Bangalore (IN)

(21) Appl. No.: 15/507,399

(22) PCT Filed: Jun. 3, 2015
(86) PCT No.: PCT/US2015/033897

§ 371 Date: Feb. 28, 2017

(30) Foreign Application Priority Data
Apr. 3, 2015 (IN) 1781/CHE/2015

(51) Int. Cl. H04L 12/741; G06F 9/455; H04L 29/12

(52) U.S. Cl. CPC H04L 45/74; H04L 61/2592; G06F 9/45558; H04L 45/02

(57) ABSTRACT

In some examples, a method includes receiving an address resolution broadcast request from a first virtual machine hosted with a network tunnel endpoint associated with an overlay network. The address resolution broadcast request may include a target internet protocol (IP) address of a second virtual machine to resolve. The method may also include parsing the address resolution broadcast request to identify the target IP address and accessing an address cache maintained by the tunnel endpoint to identify a particular MAC address of the second virtual machine that maps to the target IP address. The method may also include, without broadcasting the address resolution broadcast request to other virtual machines in the overlay network, generating an address resolution response indicating that the target IP address maps to the particular MAC address and sending the address resolution response to the first virtual machine hosted with the tunnel endpoint.

### BACKGROUND

High speed communication networks form part of the backbone of what has become indispensable worldwide data connectivity. Within the communication networks, network devices such as switching devices direct network traffic from source ports to destination ports, helping to eventually guide a data packet from a source to a destination. Improvements in the resiliency and efficiency of these communication networks will increase the effectiveness of communicating data.

### BRIEF DESCRIPTION OF THE DRAWINGS

Certain examples are described in the following detailed description and in reference to the drawings.

FIG. 1 shows an example of a host system that may implement an address cache for a tunnel endpoint associated with an overlay network.

FIG. 2 shows an example of a system that supports address caching for tunnel endpoints associated with an overlay network.

FIG. 3 shows an example of an address cache update through an address cache learn message.

FIG. 4 shows an example of an address cache update through address cache query and response messages.

FIG. 5 shows an example of an address cache update through an acknowledgment message.

FIG. 6 shows an example of host system that supports address caching, compression-decompression, and message classification for a tunnel endpoint.

FIG. 7 shows an example of logic that a tunnel endpoint may implement.

FIG. 8 shows an example of a device that may support any combination of address caching, compression-decompression, and message classification for a tunnel endpoint.

### DETAILED DESCRIPTION

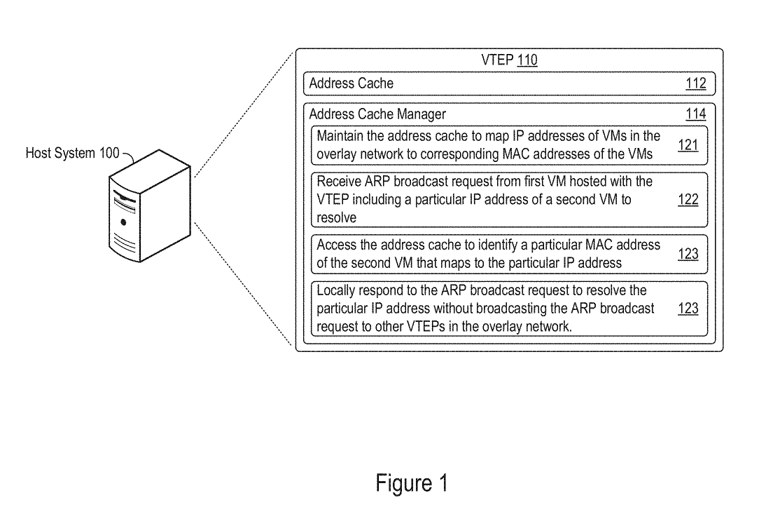

FIG. 1 shows an example of host system 100 that may implement an address cache for a tunnel endpoint associated with an overlay network. The host system 100 may be any computing device linked as part of a communication system, such as a datacenter device. As examples, the host system 100 may take the form of a router, server, switch, gateway, and more. Thus, the host system 100 may include processor(s), memory, circuitry, or other hardware to implement any of the features hosted by the host system 100.

The host system 100 may implement a tunnel endpoint associated with an overlay network. An overlay network may refer to a computer or communication network built on top of another underlying network. End devices in the overlay network (which may also be referred to as overlay network tenants) may be logically connected through virtual or logical links, and physically connected through the underlying network. One example of overlay network technology the host system 100 may support is virtual extensible local area network, also referred to as VXLAN. VXLAN may support virtualized L2 subnets (or segments) spanning across physical L3 networks, such as internet protocol (IP) networks. Thus, VXLAN may support L2 overlay networks over an L3 IP network. The Figures and description present examples through a VXLAN overlay network, though the features discussed herein may be consistently implemented for any overlay network technology and across any levels of the open systems interconnect (OSI) model. Thus, any of the address caching, compression-decompression, and message classification features discussed herein may be implemented through a tunnel endpoint or other logical entity for a generic routing encapsulation (GRE) overlay network, a distributed overlay virtual ethernet (DOVE) overlay network, or any other overlay network technology.

The host system 100 may implement or host a tunnel endpoint in an overlay network. A tunnel endpoint in a VXLAN overlay network may be referred to as a VXLAN tunnel endpoint (VTEP). In the example shown in FIG. 1, the host system 100 implements the VTEP 110. The VTEP 110 may be implemented through, for example, executable instructions stored on a machine-readable medium, logic, circuitry, or any combination thereof. The VTEP 110 may control communication flow across the L2 overlay network, such as by encapsulating messages from overlay network tenants in the L2 overlay network for communication across an L3 IP network. The VTEP 110 may thus interface to a local VXLAN segment, linking to the particular network tenants part of the local VXLAN segment, as well as to the transport IP network linking to other VTEPs associated with the overlay network.

In the example shown in FIG. 1, the VTEP 110 includes an address cache 112 and an address cache manager 114. The address cache 112 may be implemented as a cache, table, database, or other storage entity that stores address mappings for tenants of a VXLAN overlay network. A tenant of the overlay network may take the form of, as examples, a virtual machine (VM), server, or other computing device. In some examples, the address cache 112 of the VTEP 110 stores L3 to L2 address mappings for virtual machines or other end devices in the overlay network, and particularly IP address to media access control (MAC) address mappings for tenants of an overlay network. An entry of the address cache 112 may thus store the IP address for a virtual machine (or other tenant) in the overlay network as well as the corresponding MAC address for the virtual machine. In that regard, the address cache 112 may be distinct and store different information from a forwarding table of a VTEP, which may instead map MAC addresses of remote tenants in the overlay network to the IP addresses of the remote VTEPs associated with the remote tenants.

The VTEP 110 shown in FIG. 1 also includes an address cache manager 114. The address cache manager 114 may be implemented as part of the VTEP 110, for example as logic or a module of the VTEP 110. As described in greater detail below, the address cache manager 114 may locally respond to an address resolution request from a virtual machine (or other tenant) hosted with or locally linked to the VTEP 110. Instead of broadcasting the address resolution request across the overlay network to other overlay network tenants to resolve a target IP address to a corresponding MAC address, the address cache manager 114 may instead locally process the address resolution request and provide a response to the virtual machine with a corresponding MAC address for the target IP address. Also as described below, the address cache manager 114 may maintain and update the address cache 112 with additional IP address to MAC address mappings for tenants of the overlay network.

In the particular example shown in FIG. 1, the address cache manager 114 may include the modules 121, 122, 123, and 124 to implement various features that the address cache manager 114 may provide. As described in greater detail below, the address cache manager 114 (e.g., through the modules 121-124) may maintain the address cache 112 to map IP addresses of virtual machines in the overlay network to corresponding MAC addresses of virtual machines in an overlay network; receive an address resolution protocol (ARP) broadcast request from a first virtual machine hosted with the VTEP, the ARP broadcast request including a target IP address of a second virtual machine to resolve; access the address cache 112 to identify a particular MAC address of the second virtual machine that maps to the target IP address; and locally respond to the ARP broadcast request to resolve the target IP address without broadcasting the ARP broadcast request to other virtual machines in the overlay network.

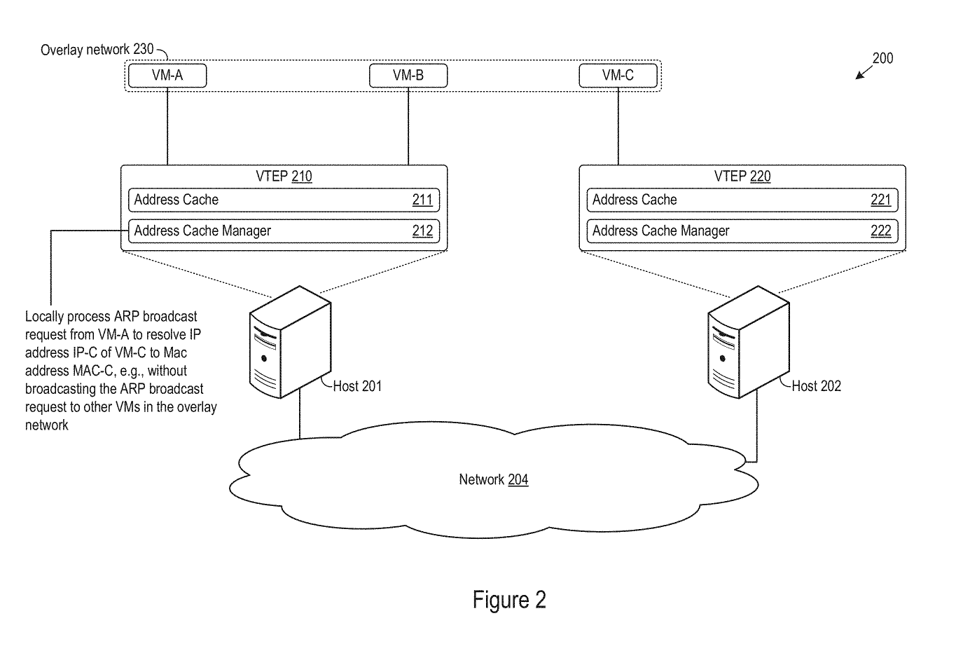

FIG. 2 shows an example of a system 200 that supports address caching for tunnel endpoints associated with an overlay network. The system 200 shown in FIG. 2 includes the host device 201, host device 202, and the communication network 204. The host devices 201 and 202 may be servers or computing devices that respectively host a VTEP for the overlay network, overlay network tenants, or both. The communication network 204 may link the various tunnel endpoints (e.g., VTEPs) for an overlay network, and may include devices, links, or other portions of an IP network for example.

In FIG. 2, the host device 201 hosts the VTEP 210, which includes the address cache 211 and the address cache manager 212. The host device 201 may host any number of end devices for an overlay network, such as the virtual machines labeled as VM-A and VM-B in FIG. 2. The host device 202 in FIG. 2 hosts the VTEP 220, which includes the address cache 221 and the address cache manager 222. The host device 202 may likewise host any number of end devices for an overlay network. In FIG. 2, the host device 202 hosts the virtual machine labeled as VM-C. The virtual machines VM-A, VM-B, and VM-C may be part of an overlay network 230, which may be a VXLAN overlay network. Accordingly, the overlay network tenants VM-A and VM-B may exchange communications with overlay network tenant VM-C through the tunnel endpoints VTEP 210 and VTEP 220.

Tenants of an overlay network may be associated with a particular VTEP for communication across the overlay network. Overlay network tenants may be associated with a particular VTEP when they are part of a local VXLAN segment linked to the VTEP. For example, a virtual machine tenant of an overlay network may be hosted with or locally linked to a particular VTEP. In the example shown in FIG. 2, the virtual machines VM-A and VM-B are hosted with the VTEP 210 together through the host device 201. As another example, the VTEP 210 may be implemented through a L2 gateway or other routing device that is locally linked to a server or other host device that hosts associated overlay network tenants, e.g., VM-A and VM-B. As yet another example noted above, the VTEP 210 and VM-A and VM-B may be associated through being part of a local VXLAN segment, in that the VTEP 210 may provide VM-A and VM-B with communication access to remote (e.g., non-local) tenants in the VXLAN overlay network by communicating VXLAN messages to other VTEPs associated with the remote tenants.

An address cache manager and address cache of a VTEP may reduce broadcast traffic in the overlay network by locally storing address mappings of remote tenants. Thus, instead of broadcasting address resolution requests across the overlay network to discover or resolve a target IP address to a corresponding MAC address (or any other address mapping), an address cache manager of a VTEP may instead query its address cache to determine whether the address mapping for the target IP address is already stored.

One illustration of address cache and address cache manager operation is provided next. VM-A may determine to communicate with VM-C through an acquired IP address of VM-C (e.g., as acquired through a domain name service (DNS) server or other IP address discovery techniques). To communicate with VM-C, VM-A may resolve the IP address of VM-C to a corresponding MAC address for VM-C, such as through generation and broadcast of an address resolution broadcast message. Address resolution protocol (ARP) is one telecommunication protocol that tenants of an overlay network may utilize to resolve addresses of other tenants, though the system 200 and components thereof may support any other address resolution techniques as well.

Continuing the illustration, VM-A may generate an address resolution request message intended for broadcast across the overlay network 230 to resolve the IP address of VM-C. In some examples, VM-A generates an ARP broadcast request specifying the IP address of VM-C as the target IP address to resolve. VM-A may pass the ARP broadcast request to the VTEP 210 for encapsulation into a VXLAN packet and broadcast across the overlay network for delivery to other tenants of the overlay network 230. Upon receiving an ARP broadcast request, the address cache manager 212 may query the address cache 211 of the VTEP 210 to determine if a mapping for the target IP address specified in the ARP broadcast request (e.g., the IP address of VM-C) is stored in the address cache 211.

When the address cache 211 of the VTEP 210 stores an IP address-MAC address mapping for VM-C, the address cache manager 212 may locally process the ARP broadcast request. That is, the address cache manager 212 may resolve the IP address of VM-C to the corresponding MAC address of VM-C without broadcasting the ARP broadcast request to other VTEPs and other tenants in the overlay network 230. Instead, the address cache manager 212 may itself generate a response to the broadcast request, such as a response that mimics the unicast ARP response packet (also referred to as an ARP reply) that VM-C would have responded with had the ARP broadcast request been broadcast across the overly network 230. In that regard, the address cache manager 212 may generate a response to the broadcast message according to a response format, syntax, or according to any other constraint set forth by the resolution protocol of the broadcast request. The address cache manager 212 may thus generate an ARP response that includes the IP address and MAC address of VM-C and send the generated ARP response to VM-A.

When the address cache 211 of the VTEP 210 does not store an IP address-MAC address mapping for VM-C, the address cache manager 212 may broadcast the ARP broadcast request across the overlay network 230, including to VM-C. VM-C may then respond with the ARP response packet specifying the MAC address of VM-C, which may resolve the IP address of VM-C. To broadcast the ARP broadcast request across the overlay network 230, the VTEP 210 may encapsulate the ARP broadcast request with a VXLAN or segment ID and broadcast on, for example, a multicast IP address to which other VTEPs for the overlay network 230 are joined.

As described above, the address cache manager of a particular VTEP may query the address cache for the particular VTEP in response to receiving a broadcast message from an overlay network tenant. The address cache manager may reduce broadcast traffic across the overlay network by instead locally servicing the broadcast request message, e.g., without broadcasting the broadcast message across the overlay network. The address cache manager may do despite the particular tenant (e.g., a different logical entity with a separate IP address and MAC address) generating the broadcast message to be broadcast across the overlay network. Put another way, the local processing of the broadcast message by the address cache manager of a particular VTEP may be transparent to the overlay network tenants associated with the particular VTEP.

To further elaborate, VM-A may be unaware when the address cache manager 212 does not broadcast an ARP broadcast request generated by VM_A to resolve the IP address of VM-C to the MAC address of VM-C. VM-A may receive an identical ARP response whether the VTEP 210 broadcasts the ARP broadcast request across the overlay network 230 (e.g., when the address cache 211 does not store an IP address-MAC address mapping for VM-C) or locally processes the ARP broadcast request (e.g., when the address cache 211 does store the IP address-MAC address mapping and locally generates the ARP response).

An address cache manager of a particular VTEP may maintain and populate the address cache for the particular VTEP in various ways. For example, the address cache manager 212 may parse an ARP broadcast request received from a locally hosted or locally linked overlay network tenant, such as VM-A or VM-B. The ARP broadcast request may specify an IP address-MAC address mapping for the source tenant (e.g., VM-A), which the address cache manager 212 may parse from the ARP address request and add an entry for in the address cache 211. As another example, the address cache manager 212 may parse an ARP response received through the overlay network 230 to identify an IP address-MAC address mapping of the overlay network tenant sending the ARP response, such as VM-C for example. Accordingly, the address cache manager 212 may perform an address cache update through entry insertion of an IP address-MAC address mapping identified through parsing an address resolution broadcast request, an address resolution response, or both.

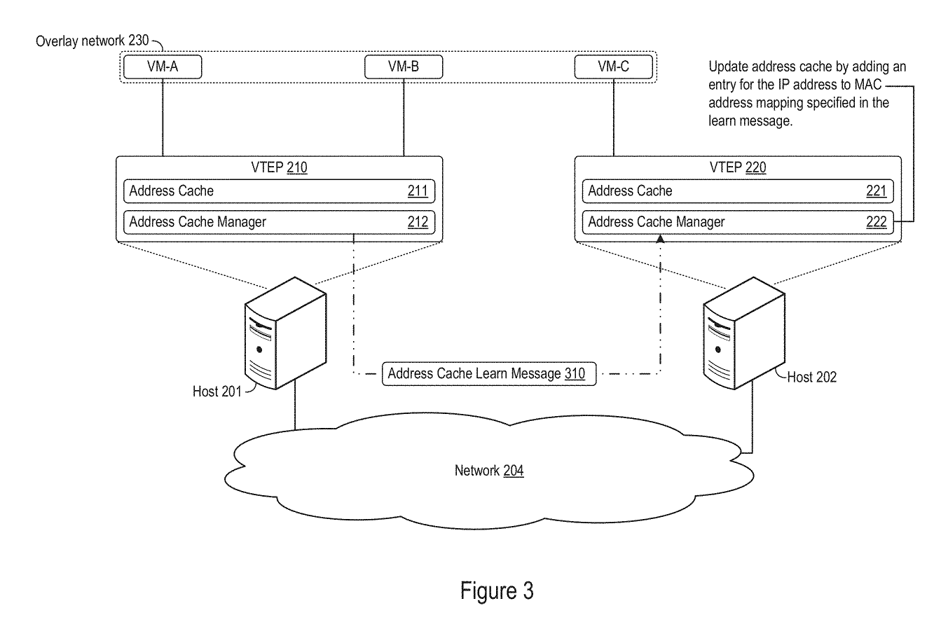

Other examples of address cache updates an address cache manager may perform are described next through FIGS. 3-5. FIG. 3 shows an example of an address cache update through an address cache learn message. An address cache manager of a particular VTEP may send an address cache learn message to the address cache manager of a different VTEP, the learn message indicating an IP address-MAC address mapping for the address cache manager of the different VTEP to insert into its address cache.

In FIG. 3, the address cache manager 212 of the VTEP 210 may generate and send the address cache learn message 310 to the address cache manager 222 of the VTEP 220. The address cache learn message 310 may specify, for example, the IP address-MAC address mapping for VM-A hosted locally with VTEP 210, which the address cache manager 212 may identify through parsing an ARP broadcast request from VM-A or in other ways. The address cache learn message 310 may include multiple IP address-MAC address mappings, e.g., mappings for multiple VM tenants in the overlay network 230 learned by the address cache manager 212.

In some examples, the address cache manager 212 generates the address cache learn message 310 as an overlay packet, e.g., as a VXLAN overlay packet meeting the packet format of VXLAN overlay packets. To identify the address cache learn message 310 as an address cache-related communication intended for processing by a receiving address cache manager of another VTEP, the address cache manager 212 may, for example, set particular header bits of in the VXLAN header or otherwise identify the address cache learn message 310 as an address cache-related communication. Accordingly, an address cache manager receiving an address cache learn message may parse a packet header to identify and process the address cache learn message, e.g. by inserting an entry into its address cache with the IP address-MAC address mapping(s) specified in the address cache learn message. In the example shown in FIG. 3, upon receiving the address cache learn message 310 from the address cache manager 212, the address cache manager 222 of the VTEP 220 may update its address cache 221 by adding an entry for the IP address-MAC address mapping specified in the address cache learn message 310.

The address cache manager 212 may generate and send the address cache learn message 310 in response to any number of events, triggers, or other criteria. In one example, the address cache manager 212 may generate the address cache learn message 310 in response to adding a new entry into its address cache 211, e.g., upon learning a particular IP address-MAC address mapping for an overlay network tenant that is not already stored in the address cache 211. In another example, the address cache manager 212 may generate the address cache learn message 310 in response to parsing an ARP broadcast request received from an associated overlay network tenant and identifying the source IP address and source MAC address of the associated overlay network tenant. In yet another example, the address cache manager 212 may generate the address cache learn message 310 upon receiving an ARP response from a remote tenant and parsing the ARP response to identify the IP address-MAC address mapping of the remote tenant, the local tenant to which the ARP response is directed to, or both. The address cache manager 212 may send the address cache learn message 310 to other VTEPs for an overlay network in none, some, or all of the above example triggers.

The address cache manager 212 may send the address cache learn message 310 to some or all of the VTEPs for an overlay network or part of a particular communication system. In some examples, the address cache manager 212 sends the address cache learn message 310 to an individual VTEP (or address cache manager for the particular VTEP). In other examples, the address cache manager 212 communicates the address cache learn message 310 by broadcasting the learn message 310 to a particular IP address of broadcast group which other VTEPs are part of, such as an internet group management protocol (IGMP) group that VTEPs for an overlay network have joined. By broadcasting learn messages across multiple VTEPs for an overlay network, the address cache learn message may be a mechanism through which various VTEPs for an overlay network populate and synchronize their address caches. Thus, multiple VTEPs in the overlay network may populate their respective address cache, which may result in reduced broadcast traffic of address resolution requests to overlay network tenants of the overlay network.

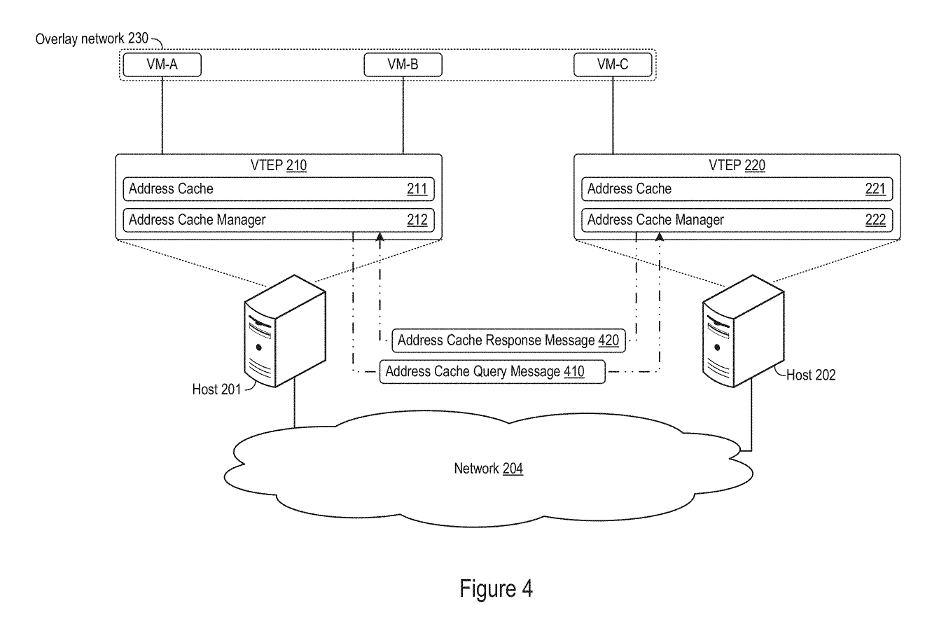

Continuing examples of various address cache updates an address cache manager may perform, FIG. 4 shows an example of an address cache update through address cache query and response messages. Address cache query and response messages may be address cache related communications that address cache managers may exchange to query and learn IP address-MAC address mappings. An address cache manager for a particular VTEP may send an address cache query message to query the address cache of a different VTEP, e.g., to resolve a particular IP address specified in an ARP broadcast request.

As one illustration shown in FIG. 4, the address cache manager 212 sends an address cache query message 410 to the address cache manager 222. The address cache manager 212 may generate and send the address cache query message 410 upon determining that its address cache 211 does not store an entry mapping a particular IP address. For example, the address cache manager 212 may receive an ARP broadcast request from VM-A or another overlay network tenant. The address cache manager 212 may parse the ARP broadcast request to identify a target IP address specified in the ARP broadcast request to resolve.

Continuing the illustration, the address cache manager 212 may then query its address cache 211 for the target IP address. When an IP address-MAC address mapping for the target IP address is stored in the address cache 211, the address cache manager 212 may locally resolve the ARP broadcast request, e.g., by generating an ARP response resolving the target IP address to a corresponding MAC address without broadcasting the ARP broadcast request to overlay network tenants and without sending an address cache query message to other VTEPs for the overlay network. When the address cache 211 does not store an entry for the target IP address included in the ARP broadcast request, the address cache manager 212 may send an address cache query message 410 to a different VTEP in the overlay network to determine whether an address cache of the different VTEP stores an entry for the target IP address of the second virtual machine.

In FIG. 4, the address cache manager 212 sends the address cache query message 410 to the address cache manager 222 to query whether the address cache 221 of the VTEP 220 stores an entry for the target IP address specified in the ARP broadcast request. The address cache manager 212 may set particular bits in a VXLAN packet header, for example, to indicate the address cache query message 410 as an address cache-related communication and specifically a query message. The address cache query message 410 may include the target address (e.g., target IP address) for the receiving address cache manager to query its address cache for.

The address cache manager 212 may broadcast the address cache query message 410 across a broadcast group that the different VTEP is part of, e.g., across an IGMP group subscribed to by various VTEPs in a communication network, and await a response. Upon receiving an address cache query message 410, an address cache manager may respond when its address cache stores an entry for the target IP address specified in the address cache query message 410. Since the address cache manager 212 may broadcast the address cache query message 410 to multiple VTEPs for an overlay network or part of a communication system, an address cache manager receiving the address cache query message 410 may respond when multiple criteria are satisfied, such as: (i) when the address cache of the receiving address cache manager stores an entry for the target IP address specified in the address cache query message; and (ii) the overlay network tenant specified by the target IP address is hosted with, locally linked to, or associated with the particular VTEP that implements the receiving address cache manger.

To explain through the example shown in FIG. 4, the address cache manager 212 may broadcast the address cache query message 410 to multiple VTEPs for an overlay network 230, including the VTEP 220 as well as other VTEPs not shown in FIG. 4. The address cache query message 410 may specify the IP address of VM-C as the target IP address to resolve. Upon reception, the VTEP 220 may identify the address cache query message 410 as an address cache-related communication and pass the address cache query message 410 for processing by the address cache manager 222 of the VTEP 220. The address cache manager 222 may retrieve the IP address-MAC address mapping for VM-C from its address cache 221 (e.g., when an entry exists) and respond with an address cache response message 420 because VM-C is associated with (e.g., locally hosted with) the VTEP 220.

Continuing the illustration, other VTEPs for the overlay network 230 may not respond to the address cache manager 212 with an address cache response message 420. This may be the case even when the respective address cache of these other VTEPs stores an IP address-MAC address mapping for VM-C, and in particular because VM-C is associated specifically with VTEP 220 and not these other VTEPs. As such, among the VTEPs to which an address cache query message 410 is broadcast to, the VTEP associated with the overlay network tenant may respond with an address cache response message 420 whereas other VTEPs may not respond with an address cache response message. As noted above, the associated VTEP may be the VTEP hosted with, locally linked to, or part of the local VXLAN segment with the overlay network tenant whose IP address is specified in the address cache query message 410.

In FIG. 4, the address cache manager 212 receives the address cache response message 420. The address cache response message 420 may specify the corresponding MAC address for the target IP address queried in the address cache query message 410. Now that that address cache manager 212 is aware of the IP address-MAC address mapping of VM-C (as learned through the address cache response message 420), the address cache manager 212 may locally process and respond to the ARP broadcast request from VM-A, thus reducing broadcast traffic to overlay network tenants. The address cache manager 212 may also add an entry into its address cache 211 with the IP address-MAC address mapping specified in the address cache response message 420.

In some examples, the address cache manager 212 may not receive a response to the address cache query message 410. This may occur when a VTEP associated with the overlay network tenant targeted by the address cache query message 410 does not store an entry for the overlay network tenant it its address cache. Referring to FIG. 4, such a scenario may occur when the address cache 221 of the VTEP 220 does not store an IP address-MAC address mapping for VM-C. Thus, when the address cache manager 212 does not receive a response to its address cache query message 410 (e.g., after a predetermined wait period), the address cache manager 212 may forego locally servicing the ARP broadcast request, and instead broadcast the ARP broadcast request to overlay network tenants. Doing so may prompt VM-C to respond to VM-A with an ARP response specifying the IP address-MAC address mapping for VM-C allowing VM-A to resolve the IP address of VM-C.

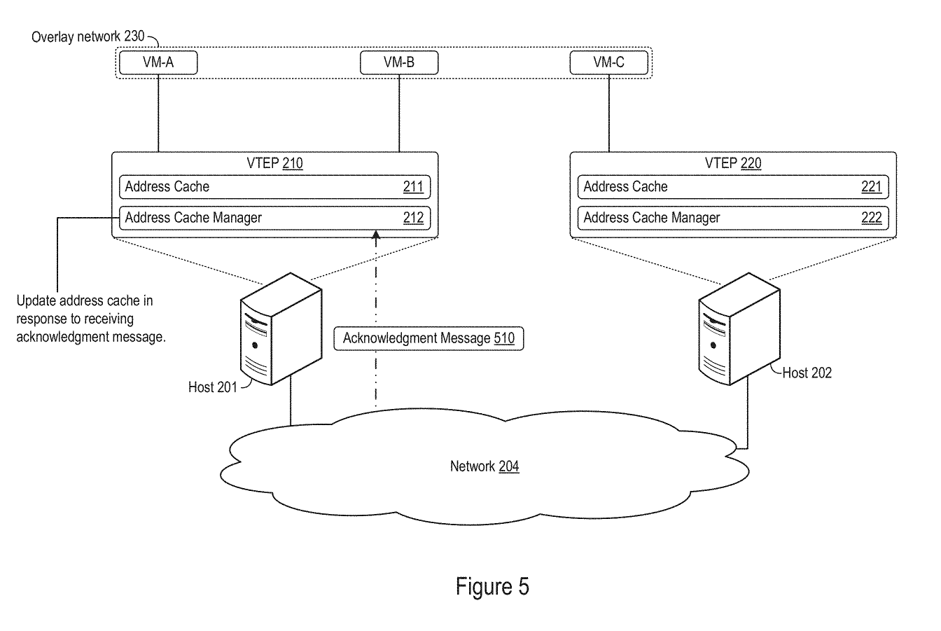

FIG. 5 shows an example of an address cache update through an acknowledgment message. In particular, the VTEP 210 may receive the acknowledgment message 510 through which the address cache manager 212 of the VTEP 210 may identify an IP address-MAC address mapping to add to the address cache 211. The acknowledgement message 510 may be an address acknowledgment, indication, or assignment message, for example as part of an IP address assignment process for an overlay network tenant associated with the VTEP 210. In some examples, the acknowledgment message 510 is dynamic host configuration protocol (DCHP) acknowledgement message, through which the address cache manager 212 may parse an assigned IP address and MAC address for VM-A or any other tenant associated with the VTEP 210. Accordingly, the address cache manager 212 may update its address cache 211 with an IP address-MAC address mapping learned through parsing an acknowledgment message.

Some examples of address cache updates an address cache manager may support were described above. An address cache manager may implement some or all of the address cache update features described herein, and in any combination. Thus, the address cache manager maintain an address cache to map address associations, such as tracking IP address-MAC address mappings for overlay network tenants.

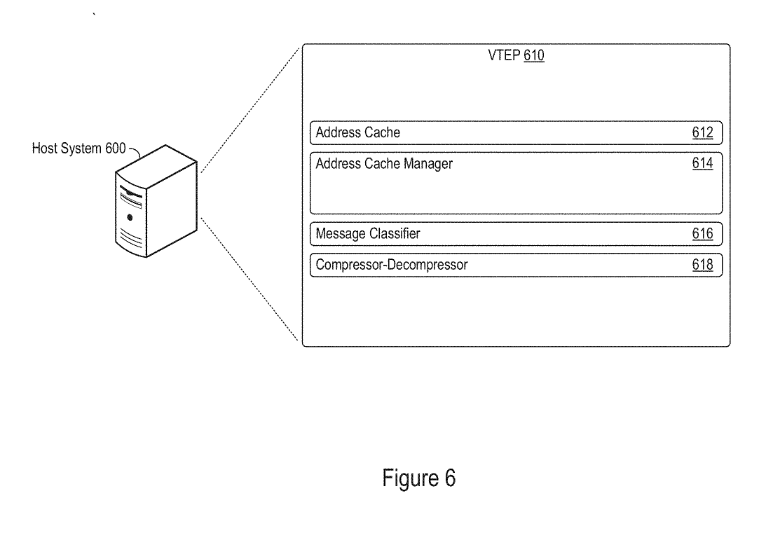

FIG. 6 shows an example of host system 600 that may support address caching, compression-decompression, and message classification for a tunnel endpoint. The host system 600 in FIG. 6 includes a VTEP 610 that implements an address cache 611 and an address cache manager 612. The VTEP 610 may thus provide any combination of the address caching features described herein through the address cache 611 and address cache manager 612.

The VTEP 610 in FIG. 6 also includes a message classifier 616. The message classifier 616 may be a module, circuitry, or logic of the VTEP 610 that supports processing of particular types of overlay packets. For example, the message classifier 616 may parse the VXLAN header of VXLAN overlay packets to identify address cache-related communications, such as address cache learn, query, and response messages received by the VTEP 610. The message classifier 616 may pass these messages to the address cache manager 612 for processing.

The message classifier 616 may also support compression and decompression of overlay packets. In that regard, the message classifier 616 may support the compressor-decompressor 618 of the VTEP 610, which may be another module, logic, or circuitry of the VTEP 610. The compressor-decompressor 618 of the VTEP 610 may compress or decompress the payload of VXLAN overlay packet, using any combination or variety of compression/decompression techniques. As the compressor-decompressor 618 is implemented as part of the VTEP 610, the VTEP 610 may support application-independent compression of overlay packets. That is, as the VTEP 610 may be a separate logical entity from client or server applications (e.g., executing on overlay network tenants such as virtual machines VM-A or VM-B), the VTEP 610 may compress VXLAN payloads regardless of the application or overlay network tenant providing the application packet.

In some examples, the VTEP 610 is configured to compress specific types of overlay packets, such as IP packets. Accordingly, the message classifier 616 may determine whether a received packet is an IP packet, and if so, pass the packet to the compressor-decompressor 618 for (i) compression and transmission across the overlay network to another VTEP, or for (ii) decompression of an overlay packet received from another VTEP and for communication to an overlay network tenant hosted with or locally linked to the VTEP 610. In some examples, the message classifier 616 may indicate or identify that an overlay packet has been compressed by setting a bit or field in an overlay packet header, e.g., in the VXLAN header of a VXLAN packet. For packet types not to be compressed/decompressed, the message classifier 616 may forego passing such packets to the compressor-decompressor 618, and the VTEP 610 may communicate such packets without compression/decompression.

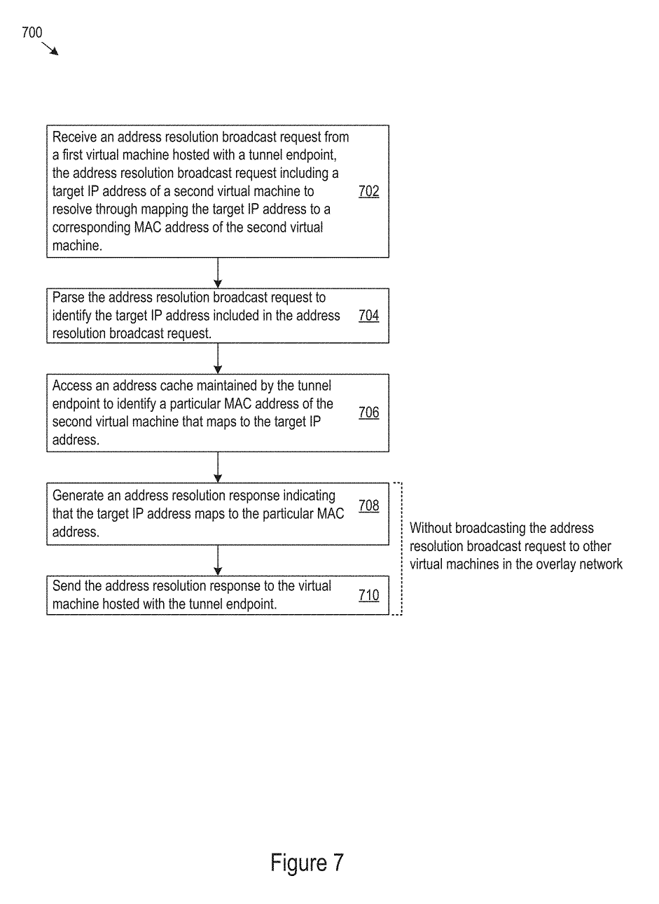

FIG. 7 shows an example of logic 700 that a tunnel endpoint may implement. The tunnel endpoint implementing the logic 700 may be, for example, a VTEP, a GRE tunnel endpoint, or any tunnel endpoint for an overlay network. The tunnel endpoint may implement the logic 700 as executable instructions stored on a machine-readable medium, for example, or in other ways. The logic 700 may be implemented as part of an address cache manager, and the logic 700 may be performed or executed as a method to support address caching in a tunnel endpoint.

In the example shown in FIG. 7, the logic 700 may be performed through tunnel endpoint associated with an overlay network (e.g., through an address cache manager of the tunnel endpoint). The tunnel endpoint may receive an address resolution broadcast request from a first virtual machine hosted with the tunnel endpoint (702). The address resolution broadcast request may include a target IP address of a second virtual machine to resolve through mapping the particular IP address to a corresponding MAC address of the second virtual machine. The address resolution broadcast request may take the form of an ARP broadcast request, for example.

The tunnel endpoint may parse the address resolution broadcast request to identify the target IP address included in the address resolution broadcast request (704). Then, the tunnel endpoint may access an address cache maintained by the tunnel endpoint to identify a particular MAC address of the second virtual machine that maps to the target IP address. Without broadcasting the address resolution broadcast request to other virtual machines in the overlay network, the tunnel endpoint may generate an address resolution response indicating that the target IP address maps to the particular MAC address (708) and send the address resolution response to the first virtual machine hosted with the tunnel endpoint (710).

As some examples, the tunnel endpoint may identify, from the address resolution broadcast request, a source IP address and a source MAC address of the first virtual machine hosted with the tunnel endpoint. In these examples, the tunnel endpoint may add an entry into the address cache maintained by the tunnel endpoint that maps the source IP address of the first virtual machine to the source MAC address of the first virtual machine. Further, the tunnel endpoint may generate an address cache learn message that maps the source IP address to the source MAC address and send the address cache learn message to a different tunnel endpoint associated with the overlay network. Doing so may cause the different tunnel endpoint to add an entry into an address cache maintained by the different tunnel endpoint that maps the source IP address of the first virtual machine to the source MAC address of the first virtual machine.

As yet another example, the tunnel endpoint may receive an address cache learn message from a different tunnel endpoint in the overlay network specifying a mapping of an IP address of a third virtual machine to a MAC address of the third virtual machine. In response, the tunnel endpoint may update its address cache by adding an entry to the address cache to reflect the mapping. As described above, the tunnel endpoint may update its address cache through receiving an acknowledgment message as well. In particular, the tunnel endpoint may receive an acknowledgement message for an IP address acquisition process specifying an assigned IP address of the first virtual machine, parse the acknowledgment message to identify the assigned IP address of the first virtual machine, and add an entry to its address cache mapping the assigned IP address of the first virtual machine to a MAC address of the first virtual machine. The acknowledgement message may take the form of a DCHP acknowledgement message.

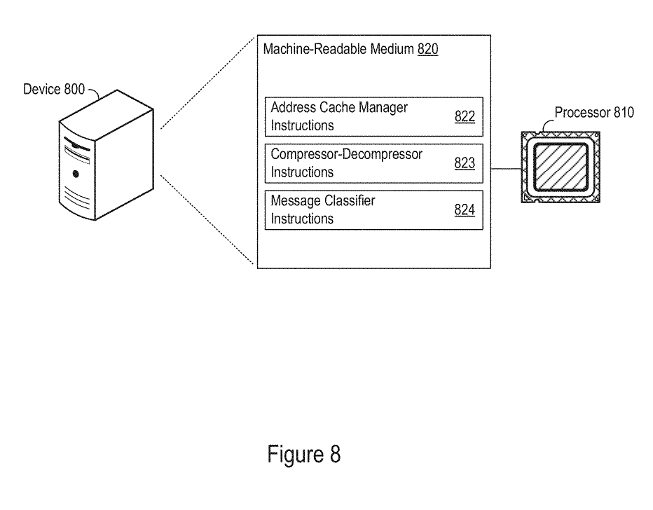

FIG. 8 shows an example of a device 800 that may support any combination of address caching, compression-decompression, and message classification for a tunnel endpoint. The device 800 may implement any of the features described herein, including according to any of the features described herein with respect to an address manager, compressor-decompressor, and message classifier.

The device 800 may include a processor 810. The processor 810 may include a central processing unit (CPU), microprocessor, and/or any hardware device suitable for executing instructions stored on a machine-readable medium. The device 800 may include a machine-readable medium 820. The machine-readable medium 820 may be any electronic, magnetic, optical, or other physical storage device that stores executable instructions, such as the address cache manager instructions 822, compressor-decompressor instructions 823, and message classifier instructions 824 shown in FIG. 8. Thus, the machine-readable medium 820 may be, for example, Random Access Memory (RAM), an Electrically-Erasable Programmable Read-Only Memory (EEPROM), a storage drive, an optical disk, and the like.

The device 800 may execute instructions stored on the machine-readable medium 820 through the processor 810. Executing the instructions may cause the device 800 to perform any combination of the features described herein. To illustrate through the address cache manager instructions 822 in FIG. 8, executing the address cache manager instructions 822 may cause the device 800 to operate according to any of the features described herein for the address cache manager. Similarly, executing the compressor-decompressor instructions 823 and the message classifier instructions 824 may cause the device 800 to operate according to any of the features described herein for the compressor-decompressor and message classifier respectively.

As one particular example with respect to address cache manager features, executing the address cache manager instructions 822 may cause the device 800 to maintain an address cache for a VTEP associated with an overlay network, the address cache to map IP addresses of virtual machines in the overlay network to corresponding MAC addresses of the virtual machines The address cache manager instructions 822 may also cause the device 800 to receive an ARP broadcast request from a first virtual machine hosted with the VTEP (the ARP broadcast request including a target IP address of a second virtual machine to resolve) and query the address cache determine whether an entry for the target IP address of the second virtual machine is stored in the address cache.

When the address cache stores an entry for the target IP address included in the ARP broadcast request, the address cache manager instructions 822 may cause the device 800 to locally process the ARP broadcast request within the VTEP to resolve the target IP address of the second virtual machine without broadcasting the ARP broadcast request to other virtual machines in the overlay network. When the address cache does not store an entry for the target IP address included in the ARP broadcast request, the address cache manager instructions 822 may cause the device 800 to send an address cache query message to a different VTEP in the overlay network to determine whether an address cache of the different VTEP stores an entry for the target IP address of the second virtual machine and receive an address cache response message from the different VTEP specifying a particular MAC address of the second virtual machine that maps to the target IP address as determined through the address cache of the different VTEP. The VTEP may receive the address cache response message from the different VTEP specifying a particular MAC address that maps to the target IP address of the second virtual machine specifically when the different VTEP is hosted with the second virtual machine.

In some examples, the address cache manager instructions 622 may cause the device 800 to, in response to receiving the address cache response message from the different VTEP, add an entry to the address cache for the VTEP that maps the target IP address of the second virtual machine to the particular MAC address of the second virtual machine. Executing the address cache manager instructions 822 may further cause the device 800 to, after receiving the address cache response message from the different VTEP, generate an ARP response to the ARP broadcast request using the address cache response message and without broadcasting the ARP broadcast request to other virtual machines in the overlay network and send the ARP response to the first virtual machine.

Various address caching, message classification, and compression-decompression features have been described above. Specific examples were provided with respect to a VTEP of a VXLAN overlay network for IP to MAC address mappings. However, the features described herein may be consistently implemented for any tunnel endpoint or other logical entity of an overlay network, and for any other type of address mappings.

The disclosure above may provide for increased efficiency in a communication network through reduced communication traffic. In particular, the VTEP, address cache manager, message classifier, and compressor-decompressor features described herein may reduce broadcast and multicast traffic in an overlay network, for example by reducing address resolution requests broadcast across the overlay network to overlay network tenants. As a result, the features described herein may reduce network congestion and resource consumption. Moreover, the features described above may provide for compression and decompression of overlay network traffic on an application-independent level, which may result in lesser data traffic and increased communication efficiency.

The methods, devices, systems, and logic described above, including the address cache manager, message classifier, and compressor-decompressor, may be implemented in many different ways in many different combinations of hardware, executable instructions stored on a machine-readable medium, or both. For example, a VTEP, address cache manager, message classifier, or compressor-decompressor may include circuitry in a controller, a microprocessor, or an application specific integrated circuit (ASIC), or may be implemented with discrete logic or components, or a combination of other types of analog or digital circuitry, combined on a single integrated circuit or distributed among multiple integrated circuits. A product, such as a computer program product, may include a storage medium and machine readable instructions stored on the medium, which when executed in an endpoint, computer system, or other device, cause the device to perform operations according to any of the description above.

The processing capability of the systems, devices, and circuitry described herein, including the address cache manager, message classifier, and compressor-decompressor, may be distributed among multiple system components, such as among multiple processors and memories, optionally including multiple distributed processing systems. Parameters, databases, and other data structures may be separately stored and managed, may be incorporated into a single memory or database, may be logically and physically organized in many different ways, and may implemented in many ways, including data structures such as linked lists, hash tables, or implicit storage mechanisms. Programs may be parts (e.g., subroutines) of a single program, separate programs, distributed across several memories and processors, or implemented in many different ways, such as in a library, such as a shared library (e.g., a dynamic link library (DLL)). The DLL, for example, may store code that performs any of the system processing described above.

While various examples have been described above, many more implementations are possible.

1. A method comprising:
through a tunnel endpoint associated with an overlay network:
receiving an address resolution broadcast request from a first virtual machine hosted with the tunnel endpoint, the address resolution broadcast request including a target internet protocol (IP) address of a second virtual machine to resolve through mapping the particular IP address to a corresponding media access control (MAC) address of the second virtual machine;
parsing the address resolution broadcast request to identify the target IP address included in the address resolution broadcast request;
accessing an address cache maintained by the tunnel endpoint to identify a particular MAC address of the second virtual machine that maps to the target IP address; and
without broadcasting the address resolution broadcast request to other virtual machines in the overlay network:
generating an address resolution response indicating that the target IP address maps to the particular MAC address; and
sending the address resolution response to the first virtual machine hosted with the tunnel endpoint.

2. The method of claim 1, further comprising:
identifying, from the address resolution broadcast request, a source IP address and a source MAC address of the first virtual machine hosted with the tunnel endpoint; and
adding an entry into the address cache maintained by the tunnel endpoint mapping the source IP address of the first virtual machine to the source MAC address of the first virtual machine.

3. The method of claim 2, further comprising:
generating an address cache learn message that maps the source IP address to the source MAC address; and
sending the address cache learn message to a different tunnel endpoint associated with the overlay network to cause the different tunnel endpoint to add an entry into an address cache maintained by the different tunnel endpoint that maps the source IP address of the first virtual machine to the source MAC address of the first virtual machine.

4. The method of claim 1, further comprising:
receiving an address cache learn message from a different tunnel endpoint in the overlay network specifying a mapping of an IP address of a third virtual machine to a MAC address of the third virtual machine; and
adding an entry to the address cache to reflect the mapping.

5. The method of claim 1, further comprising:
receiving an acknowledgement message for an IP address acquisition process specifying an assigned IP address of the first virtual machine;
parsing the acknowledgment message to identify the assigned IP address of the first virtual machine; and
adding an entry to the address cache mapping the assigned IP address of the first virtual machine to a MAC address of the first virtual machine.

6. The method of claim 5, wherein the acknowledgement message comprises a dynamic host configuration protocol (DCHP) acknowledgement message.

7. A system comprising:
a virtual extensible local area network tunnel endpoint (VTEP) associated with an overlay network, the VTEP comprising:
an address cache; and
an address cache manager to:
maintain the address cache to map internet protocol (IP) addresses of virtual machines in the overlay network to corresponding media access control (MAC) addresses of the virtual machines;
receive an address resolution protocol (ARP) broadcast request from a first virtual machine hosted with the VTEP, the ARP broadcast request including a target IP address of a second virtual machine to resolve;
access the address cache to identify a particular MAC address of the second virtual machine that maps to the target IP address; and
locally respond to the ARP broadcast request to resolve the target IP address without broadcasting the ARP broadcast request to other virtual machines in the overlay network.

8. The system of claim 7, wherein the VTEP further comprises a compressor-decompressor to:
compress a payload of an outgoing overlay packet before transmission of the overlay packet by the VTEP; and
decompress an incoming overlay packet received by the VTEP.

9. The system of claim 8, wherein the VTEP further comprises a message classifier to:
receive a packet generated by the virtual machine hosted with the VTEP;
pass the packet to the compressor-decompressor for compression of a payload of the packet when the packet meets a compression criterion; and
transmit the packet from the VTEP without compressing the payload of the packet.

10. The system of claim 9, wherein the compression criterion is satisfied when the packet is an IP packet.

11. The system of claim 7, wherein the address cache manager is further to:
identify, from the ARP broadcast request, a source IP address and source MAC address of the first virtual machine hosted with the VTEP; and
add an entry into the address cache maintained by the VTEP mapping the source IP address of the first virtual machine to the source MAC address of the first virtual machine.

12. A non-transitory machine readable medium storing executable instructions to:
maintain an address cache for a virtual extensible local area network tunnel endpoint (VTEP) associated with an overlay network, the address cache to map internet protocol (IP) addresses of virtual machines in the overlay network to corresponding media access control (MAC) addresses of the virtual machines;
receive an address resolution protocol (ARP) broadcast request from a first virtual machine hosted with the VTEP, the ARP broadcast request including a target IP address of a second virtual machine to resolve;
query the address cache determine whether an entry for the target IP address of the second virtual machine is stored in the address cache; and
when the address cache stores an entry for the target IP address included in the ARP broadcast request:
locally process the ARP broadcast request within the VTEP to resolve the target IP address of the second virtual machine without broadcasting the ARP broadcast request to other virtual machines in the overlay network; and
when the address cache does not store an entry for the target IP address included in the ARP broadcast request:
send an address cache query message to a different VTEP in the overlay network to determine whether an address cache of the different VTEP stores an entry for the target IP address of the second virtual machine; and
receive an address cache response message from the different VTEP specifying a particular MAC address of the second virtual machine that maps to the target IP address as determined through the address cache of the different VTEP.

13. The non-transitory machine readable medium of claim 12, wherein the executable instructions are to receive the address cache response message from the different VTEP specifying a particular MAC address that maps to the target IP address of the second virtual machine when the different VTEP is hosted with the second virtual machine.

14. The non-transitory machine readable medium of claim 12, wherein the executable instructions are further to, in response to receiving the address cache response message from the different VTEP:
add an entry to the address cache for the VTEP that maps the target IP address of the second virtual machine to the particular MAC address of the second virtual machine.

15. The non-transitory machine readable medium of claim 12, wherein the executable instructions are further to, after receiving the address cache response message from the different VTEP:
generate an ARP response to the ARP broadcast request using the address cache response message and without broadcasting the ARP broadcast request to other virtual machines in the overlay network; and
send the ARP response to the first virtual machine.
